(19) United States
(12) Patent Application Publication
(10) Pub. No.: US 2014/0354920 A1
(43) Pub. Date: Dec. 4, 2014

(54) MULTI-PANEL DISPLAY APPARATUS AND MANUFACTURING METHOD THEREOF

(71) Applicant: SAMSUNG DISPLAY CO., LTD., Yongin-City (KR)

(72) Inventors: Hyeonggyu JANG, Yongin-City (KR); Byung Han YOO, Yongin-City (KR); Moongyu LEE, Yongin-City (KR); Byoungho CHEONG, Yongin-City (KR); Oleg PRUDNIKOV, Yongin-City (KR)

(73) Assignee: SAMSUNG DISPLAY CO., LTD., Yongin-City (KR)

(21) Appl. No.: 14/253,272

(22) Filed: Apr. 15, 2014

(30) Foreign Application Priority Data
May 28, 2013 (KR) 10-2013-0060468

(51) Int. Cl. G02F 1/1333

(52) U.S. Cl. CPC G02F 1/13336; G02F 1/1333
USPC 349/73; 445/24

(57) ABSTRACT

A multi-panel display apparatus includes at least two display panels and an optical member. Each display panel includes a display area and a connection non-display area. The optical member displays light emitted from peripheral regions of the display areas of the display panels. The optical member includes an adhesive layer between laminated sheets. Each sheet includes a base film made of a transparent material having a first refractive index and a reflection layer at a surface of the base film made of metal. The adhesive layer is made of a material having a second refractive index less than the first refractive index.

### CROSS-REFERENCE TO RELATED APPLICATION

Korean Patent Application No. 10-2013-0060468, filed on May 28, 2013, and entitled, “Multi-Panel Display Apparatus and Manufacturing Method Thereof,” is incorporated by reference herein in its entirety.

### BACKGROUND

1. Field

One or more embodiments described herein relate to a display apparatus.

2. Description of the Related Art

A flat panel display, such as liquid crystal display or plasma display panel, achieves high resolution on a large screen. However, when the screen exceeds a predetermined size, manufacturing costs substantially increase and image quality deterioration becomes more likely, for example, as a result of signal delays.

Attempts have been made to overcome these drawbacks. One attempt involves making the display from multiple display panels. Displays of this type have been used for advertising purposes on top of a building. They also have been used as electronic sign boards in a sports complex and as live displays in concerts. However, these displays are not optimal because the display panels have non-display areas along their edges which tend to cut off significant portions of the images.

### SUMMARY

In accordance with one embodiment, a multi-panel display apparatus includes first and second display panels, each display panel including a display area to display an image and a connection non-display area adjacent the display area; and an optical member having a first side, corresponding to portions of the display areas of the first and second display panels, and a second side, corresponding to the connection non-display areas of the first and second panels, connection non-display areas located between the display areas of the first and second display panels, the optical member to display images from portions of the display areas of the first and second display panels.

The optical member includes an adhesive layer between at least two laminated sheets, each of the laminated sheets including a base film made of a transparent material having a first refractive index and a reflection layer at a first surface of the base film made of metal, and wherein the adhesive layer is provided at a second surface of the base film and is made of a material having a second refractive index less than the first refractive index. A shape of the optical member may be a polyhedron having at least five faces.

The optical member may include a curved surface to display the image. The display area of each of the first and second display panels may includes a main pixel portion and a peripheral pixel portion between the main pixel portion and a corresponding connection non-display area, wherein the optical member is disposed on the peripheral pixel portion.

A first end of each of the laminated sheets may correspond to a single pixel array of the peripheral pixel portion, and a second end of each of the laminated sheets may be included at a different angle from the first end of each of the laminated sheets. Sections of the second ends of the laminated sheets may have at least two different inclined angles.

A supporter may be included on the connection non-display areas of the first and second display panels to support the optical member. The laminated sheets may be substantially parallel to a side surface of the supporter.

A portion of light impinging on one end of the base film may be totally reflected at a boundary between the base film and the adhesive layer. The base film may be made of polycarbonate (PC), polyethylene terephthalate (PET), polyurethane (PU), or polymethylmethacrylate (PMMA). The reflection layer may be made of aluminum, silver, nickel, or a combination thereof.

In accordance with another embodiment, a multi-panel display apparatus includes first and second display panels, each including a display area to display an image and a connection non-display area adjacent to the display area; and an optical member having a first side corresponding to portions of the display areas of the first and second display panels and a second side on the connection non-display areas of the first and second display panels, the connection non-display areas located between the display areas of the first and second display panels, the optical member to display images from portions of the display areas of the first and second display panels.

The optical member includes an adhesive layer between at least two laminated sheets, each of the laminated sheets including: a base film made of a transparent material having a first refractive index, an interleaved adhesive layer at a first surface of the base film made of a material having a second refractive index less than the first refractive index, and a reflection film on the base film and the interleaved adhesive layer disposed therebetween to face the base film, and wherein the adhesive layer is provided at a second surface of the base film and is made of a material having a third refractive index less than the first refractive index.

The reflection film may be an Enhanced Specular Reflector (ESR) film. The second refractive index and the third refractive index may be substantially equal to each other. Some light impinging on one end of the base film may be totally reflected at a boundary between the base film and the adhesive layer.

In accordance with another embodiment, a method of making a multi-panel display apparatus includes forming at least two laminated sheets, foaming a laminate in which an adhesive layer is disposed between the laminated sheets, cutting the laminate in a predetermined shape, and attaching the cut laminate to a plurality of display panels.

Forming the laminated sheets may include preparing a base film and depositing a metal on the base film to form a reflection layer. Forming the laminate may include coating an adhesive between the laminated sheets; pressing the laminated sheets coated with the adhesive; and curing the adhesive to form the adhesive layer.

In accordance with one embodiment, a multi-panel display apparatus includes a first display panel, a second display panel, and an optical waveguide over display areas of the first and second display panels, wherein the optical waveguide passes light from the display areas to inclined surfaces of a region between the display areas of the first and second display panels, and wherein the light emitted from each display area corresponds to a different image.

A first inclined surface of the optical waveguide may overlap a peripheral portion of the display area of the first display panel, and a second inclined surface of the optical waveguide may overlap a peripheral portion of the display area of the second display panel, the first inclined surface connected to the second inclined surface at a location which corresponds to a boundary between non-display areas of the first and second display panels.

### BRIEF DESCRIPTION OF THE DRAWINGS

Features will become apparent to those of skill in the art by describing in detail exemplary embodiments with reference to the attached drawings in which:

FIG. 1 illustrates an embodiment of a display apparatus;

FIG. 2 illustrates a sectional view of the display apparatus along the line I-I′;

FIG. 3 illustrates the sectional view along line I-I′ from another perspective;

FIG. 4 illustrates laminated sheets with an intervening adhesive layer;

FIG. 5 illustrates a sectional view along line I-I′ from another perspective;

FIG. 6 illustrates an example of luminance of incident and emitted light;

FIGS. 7A-7C illustrate an embodiment of a method for making an optical member;

FIG. 8 illustrates another arrangement of laminated sheets of an optical member;

FIG. 9 illustrates a ratio of reflected light based on a number of reflections;

FIG. 10 illustrates the luminance of incident and emitted light;

FIGS. 11 to 13 illustrate examples of shapes of different optical members.

### DETAILED DESCRIPTION

Example embodiments are more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

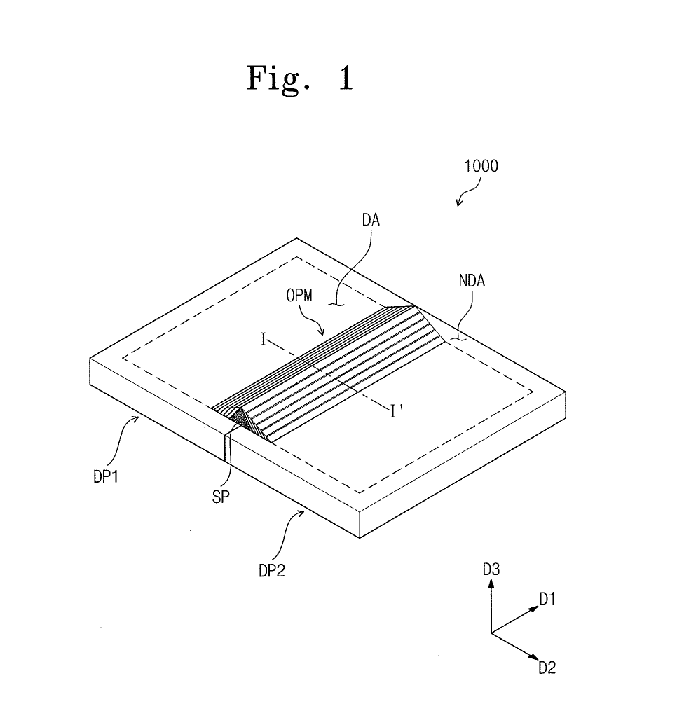

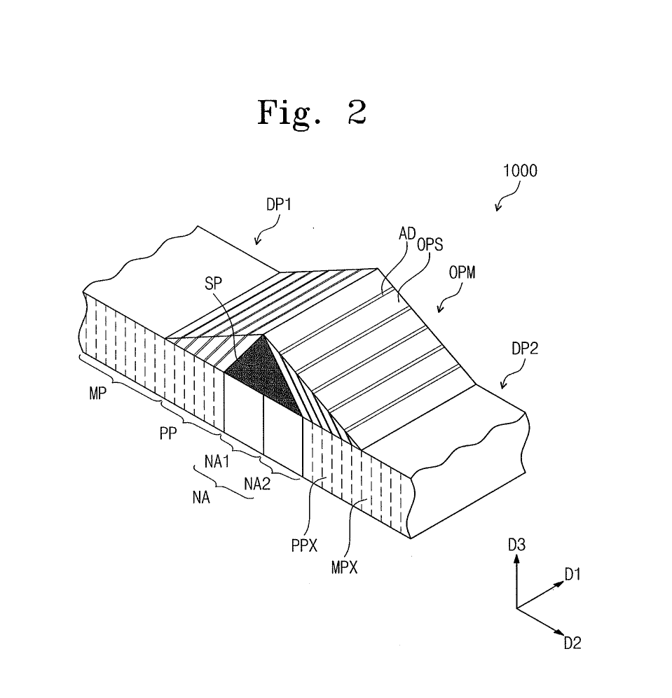

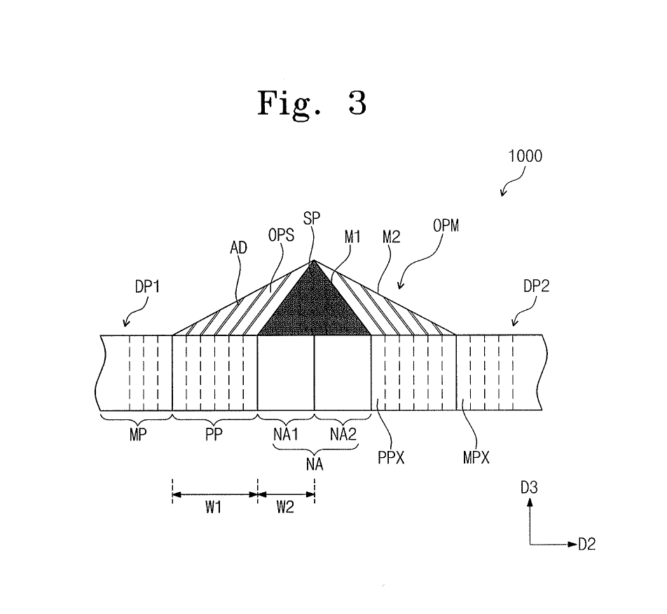

FIG. 1 illustrates an embodiment of a display apparatus 1000. FIG. 2 illustrates a perspective view of a portion of the display apparatus 1000, and shows a cross section taken along the line I-I′ in FIG. 1. FIG. 3 illustrates a cross-sectional view taken along the line I-I′ in FIG. 1.

Referring to FIGS. 1 to 3, the display apparatus 1000 includes display panels DP1 and DP2 to display images and an optical member OPM connected to the display panels DP1 and DP2. The display panels DP1 and DP2 may be provided on a same plane or may be provided on a curved or bent surface. The display panels DP1 and DP2 may have a fixed shape or a non-fixed (e.g., flexible) shape. The display panels DP1 and DP2 may be, for example, organic light emitting display panels, liquid crystal display panels, electrowetting display panels, electrophoretic display panels, micro-electromechanical system (MEMS) display panels, or plasma display panels.

For example, when display panels DP1 and DP2 are liquid crystal display panels, each display panel may include a base substrate, a counter substrate facing the base substrate, and a liquid crystal layer disposed between the base substrate and the counter substrate. In one embodiment, the base substrate may include a plurality of pixel electrodes and a plurality of thin film transistors electrically connected in one-to-one correspondence to the pixel electrodes. Each of the thin film transistors switches a driving signal provided to the side of a corresponding pixel electrode. The counter substrate may include a common electrode that establishes an electric field for controlling an array of liquid crystals. The display panel drives the liquid crystal layer to display an image forward.

In one embodiment, the display panels may all be the same type of panel. In another embodiment, different types of display panels may be provided. Also, the panels may all be of a same size or two or more of the panels may have different sizes. Moreover, while two panels DP1 and DP2 are shown in FIGS. 1-3, some embodiments may have more than two panels.

The display panels DP1 and DP2 may have a predetermined thickness and may have a rectangular shape. In this case, one pair of sides may be longer than the other pair of sides. The direction of the pair of longer sides may be considered to correspond to a first direction D1, and the direction of the pair of shorter sides may be considered to correspond to a second direction D2. A direction for displaying an image to a viewer may be considered to correspond a third direction D3, which is an upper direction perpendicular to the first and second directions D1 and D2.

In one embodiment, an embodiment having only two display panels DP1 and DP2 connected in the second direction D2 will be discussed as an example. For convenience of explanation, the two display panels will be indicated as a first display panel DP1 and a second display panel DP2.

The first display panel DP1 and the second display panel DP2 are disposed adjacent to each other in the second direction D2. Adjacent sizes of these panels may contact or be spaced from one another. A fixing member may fix the first and second display panels DP1 and DP2 when their adjacent sides are spaced from one another.

The first display panel DP1 and the second display panel DP2 may include a display area DA in which an image is displayed, and a non-display area NDA adjacent the display area DA when viewed from a plane. The non-display area NDA is an area in which no image is displayed, and in the example illustrated in FIG. 1 is provided along a circumference of the display area DA.

The non-display area NDA may include a connection non-display area NA between the display area DA of the first display panel and the display area DA of the second display panel DP2 that are adjacent to each other in the second direction D2. The connection non-display area NA includes a first connection non-display area NA1 in the first display panel DP1 and a second connection non-display area NA2 in the second display panel DP2.

The display area DA includes a plurality of pixels MPX and PPX arranged in a matrix. Each of the pixels MPX and PPX is provided with a pixel electrode and one or more thin film transistors connected to the pixel electrode. The pixel electrode establishes an electric field at the liquid crystal layer together with the common electrode to display an image.

The display area DA includes a main pixel portion MP and a peripheral pixel portion PP formed at one side of the main pixel portion MP. The main pixel portion MP is provided with a plurality of main pixels MPX, and the peripheral pixel portion PP is provided with a plurality of peripheral pixels PPX. The peripheral pixel portion PP is provided adjacent to the connection non-display area NA in the first direction. That is, in the first display panel DP1, the peripheral pixel portion PP is provided between the main pixel portion MP and the first connection non-display area NA1. In the second display panel DP2, the peripheral pixel portion PP is provided between the main pixel portion MP and the second connection non-display area NA2.

The display apparatus 1000 may further include a supporter SP provided on the connection non-display area NA. The supporter SP serves to support the optical member OPM. In an embodiment, the supporter SP may have the shape of a pentahedron having a bottom face corresponding to the connection non-display area NA. In the example illustrated in FIGS. 1-3, the second-direction (D2) side face of the supporter SP is provided in the form of two rectangles that are inclined relative to a plane formed by the first direction D1 and the second direction D2. Referring to FIG. 3, a sectional shape of the supporter SP may be isosceles triangle having a base corresponding to the connection non-display area NA. In an alternative embodiment, the supporter SP may be omitted if the optical member OPM is fixed on and thus supported by the display panels DP1 and DP2.

The optical member OPM is provided on the peripheral pixel portion PP and the connection non-display area NA to display an image. The optical member OPM may be provided on the first display panel DP1 and the second display panel DP2. The optical member OPM may be symmetrical with respect to the supporter SP. In one embodiment, the optical member OPM may be provided in the form of pentahedron.

A bottom face of the optical member OPM is disposed on the peripheral pixel portion PP. One side face M1 of the optical member OPM is disposed on one side face of the supporter SP, and may have the same inclined angle as the one side face of the supporter SP relative to a plane formed by the first and second directions D1 and D2. The one side face M1 of the optical member OPM and the one side face of the supporter SP may be adhered to each other, for example, by an adhesive. The other side face M2 of the optical member OPM may have a different inclined angle relative to the same plane formed by the first and second directions D1 and D2. The bottom face, side face M1, and side face M2 of the optical member OPM may be all in the form of quadrangle.

The optical member OPM may include a plurality of laminated sheets OPS and an adhesive layer AD disposed between pairs of the laminated sheets. The laminated sheets may have different heights in the third direction D3.

Each of the laminated sheets OPS may be disposed parallel to the side face of the supporter SP. A first end of each laminated sheet OPS may have a section parallel to the plane formed by the first and second directions D1 and D2. The first end of each of the laminated sheets OPS may be a portion of the bottom face of the optical member OPM. A second end of each of the laminated sheets may have a section inclined to the plane formed by the first and second directions D1 and D2. The second end of each of the laminated sheets OPS may be a portion of side face M2 of the optical member OPM.

A section of the second end of each of the laminated sheets OPS may have a larger area than that of the first end of each of the laminated sheets OPS. Accordingly, when an image having a predetermined area is provided to one end of each of the laminated sheets OPS, an image having a larger area than the predetermined area is displayed on the other end of each of the laminated sheets OPS.

In the first display panel DP, a width in the second direction D2 of the peripheral pixel portion PP may be referred to as first width W1 and a width of the first connection non-display area NA1 may be referred to as second width W2. The first ends of the laminated sheets OPS may therefore have an area corresponding to the first width W1, and second ends of the laminated sheets OPS may have an area corresponding to a sum of the first width W1 and the second width W2.

One end of each of the laminated sheets OPS may be disposed to correspond to a single pixel array arranged in the first direction D1, among pixels PPX of the peripheral pixel portion PP. Thus, an image displayed at the single pixel array may impinge on one end of each of the laminated sheets OPS and may be displayed on the other end of each of the laminated sheets OPS.

In the display apparatus 1000, operation of the first display panel DP1 and the second display panel DP2 may be synchronized in order to display an image. In other embodiments, the first and second display panels DP1 and DP2 may display different images. In other embodiments, the first and second display panels DP1 and DP2 may display the same image at a first time and different images at a second time.

The display apparatus 1000 prevents an image cut-off problem and an image distortion phenomenon from occurring at adjacent edges of (or boundary between) the display panels. Moreover, because a non-display area between adjacent display panels is covered and images are not viewed by a user's eye, an image displayed by each of the display panels is connected to an adjacent image.

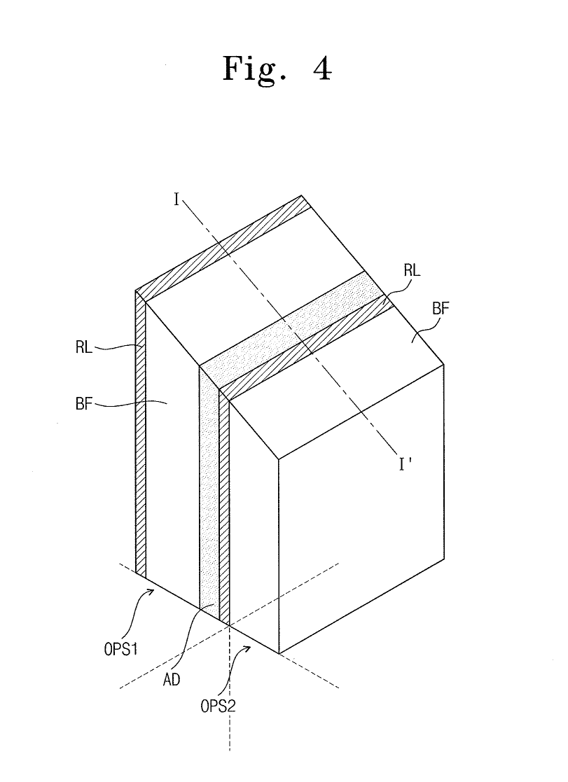

FIG. 4 illustrates a perspective view of two adjacent laminated sheets OPS1 and OPS2 and an adhesive layer AD therebetween. Referring to FIG. 4, the laminated sheets OPS1 and OPS2 may include a base film BF and a reflection layer RL.

The base film BF may be made of a transparent insulating material. The base film BF may be a medium through which incident light emitted from the peripheral pixel portion PP in FIGS. 2 and 3 travels. Specifically, incident light may impinge on one end of the base film BF and pass through the inside of the base film BF by reflection, or a total reflection mechanism, using reflection layer RL and adhesive layer AD. As a result, light is emitted to the other end of the base film BF.

The base film BF may be made of, for example, polycarbonate (PC), polyethylene terephthalate (PET), polyurethane (PU), or polymethylmethacrylate (PMMA). In other embodiments, the base film BF may be made of another type of transparent material, e.g., one having a greater refractive index than adhesive layer AD.

The reflection layer RL may be provided at one surface of the base film BF. The reflection layer RL serves to reflect a light traveling to the boundary with the base film BF and the boundary with the adhesive layer AD. The reflection layer RL may be made, for example, of a metal having a relatively high reflectance. The reflection layer RL may be made of, for example, aluminum (Al), silver (Ag), nickel (Ni), or an alloy thereof. Referring to FIGS. 2 to 4, the reflection layer RL may be a first layer of the optical member OPM adjacent to the supporter SP. Accordingly, a side face of the supporter SP and the reflection layer RL may be adhered to each other by an adhesive.

Returning to FIG. 4, the adhesive layer AD may be provided at the other end of the base film BF. The adhesive layer AD allows the base film BF and another adjacent laminated sheet OPS2 to adhere to each other. The laminated sheets OPS1 and OPS2 may be adhered to each other by the adhesive layer AD. The adhesive layer AD may be made of a material (e.g., OCA) having, for example, a lower refractive index than the base film BF. In one embodiment, the adhesive layer AD is made of a material having a refractive index of 1.47.

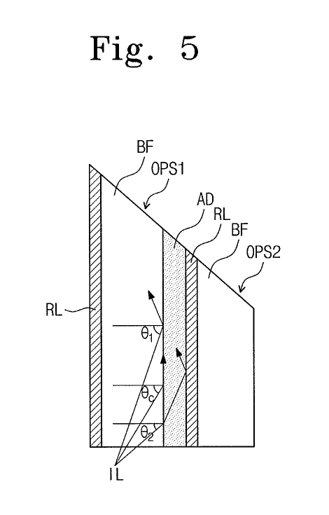

FIG. 5 illustrates a cross-sectional view taken along the line I-I′ in FIG. 1. Referencing this cross-sectional view, a process of emitting incident light IL impinging on one end of the laminated sheet OPS1 to the other end of the laminated sheet OPS1 through the laminated sheet OPS1 will be described.

Referring to FIG. 5, incident light IL impinging on one end of the base film BF may have a plurality of incident angles. The incident light IL may be light emitted from the peripheral pixel portion PP shown in FIG. 3, and therefore may have a light flux emitted in all directions. Because the base film BF has a higher refractive index than the adhesive layer AD, a critical angle θ_{C} may be formed. Critical angle θ_{C} refers to a condition that may cause total internal reflection. Thus, according to Snell's Law, if incident angle IL is at the critical angle θ_{C}, the incident angle IL travels along the boundary between the base film BF and the adhesive layer AD.

If the incident angle IL is a first angle θ₁ greater than the critical angle θ_{C}, the incident light IL is totally reflected at the boundary between the base film BF and the adhesive layer AD, to impinge on the reflection layer RL. The light impinging on the reflection layer RL is reflected again to be totally and repeatedly reflected at the boundary between the base film BF and the adhesive layer AD.

If the incident angle IL is a second angle θ₂ smaller than the critical angle θ_{C}, the incident light IL passes through the adhesive layer AD and is reflected by a reflection layer of an adjacent laminated sheet OPS2, to impinge into the base film BF after passing again through the adhesive layer AD.

Of the incident light IL, a light impinging to the reflective layer RL is reflected at the reflection layer RL and travels toward the adhesive layer AD at one incident angle of the first and second angles θ₁ and θ₂. Thus, the base film BF, adhesive layer AD, and the reference layer RL may be considered to form a waveguide.

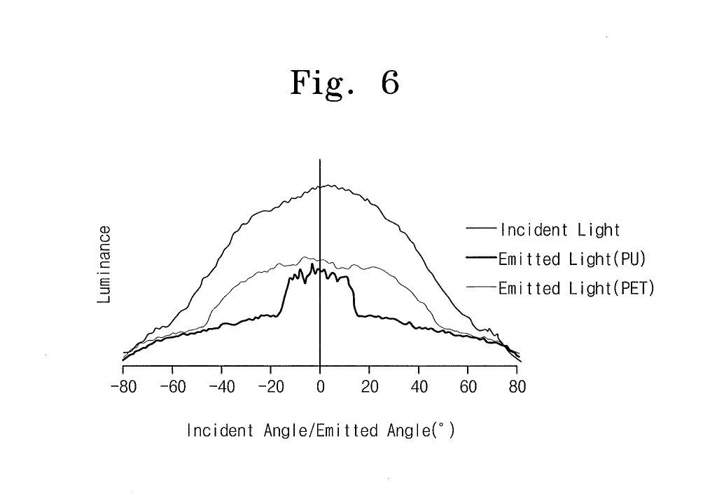

FIG. 6 is a graph illustrating the luminance of incident and emitted light at each of a plurality of incident/emission angles. In FIG. 6, emitted light is shown in the illustrative case of when a base film is made of polyethylene terephthalate (PET) and polyurethane (PU).

Referring to FIG. 6, when the base film BF is made of polyethylene terephthalate (PET), a critical angle is 44.8 degrees because a refractive index of the PET is 1.63 and a refractive index of the adhesive layer AD is 1.47. As can be seen from FIG. 6, the luminance of emitted light increases within a range between −44.8 degrees and +44.8 degrees. Accordingly, it may be seen that there is practically a luminance increase effect of the emitted light, which is achieved by total reflection between the base film BF and the adhesive layer AD.

In addition, if the base film BF is made of polyurethane (PU), a critical angle is 9.8 degrees because a refractive index of the PU is 1.48 and a refractive index of the adhesive layer AD is 1.47. As can be seen from FIG. 6, the luminance of emitted light increases within a range between −9.8 degrees and +9.9 degrees. Accordingly, it may be seen that there is practically a luminance increase effect of the emitted light, which is achieved by total reflection between the base film BF and adhesive layer AD, although a difference in refractive index between the base film BF and the adhesive layer AD may not be great.

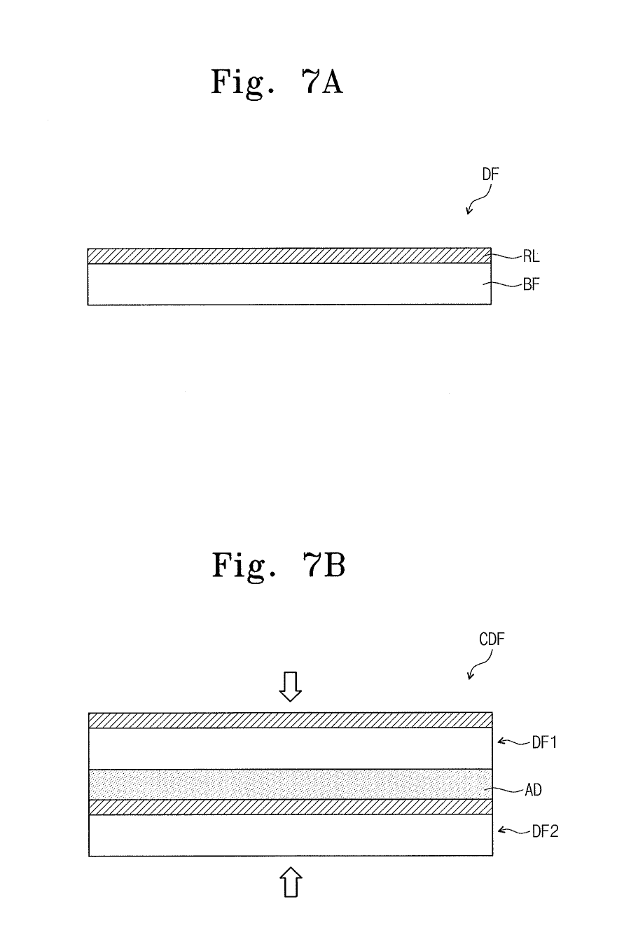

FIGS. 7A and 7C illustrate an embodiment of a method for manufacturing an optical member. Referring to FIG. 7A, a transparent base film BF is provided. A material constituting the base film BE was explained with reference to FIG. 4 and will not be explained in further detail.

A reflection layer RL is formed on one surface of the base film BF. The reflection layer RL may be formed, for example, by stacking a metal on the base film BF. The metal corresponding to the reflection layer RL was explained with reference to FIG. 4 and will not be explained in further detail.

Thus, a deposition film DF where the reflection layer RL is deposited on the base film BF is completed. A plurality of deposition films DF may be formed in the same manner. Two deposition films DF1 and DF2 will be explained as an example.

Referring to FIG. 7B, an adhesive is coated on one surface of one deposition film DF1 and the other deposition film DF2 is disposed on the deposition film DF1. The adhesive is interposed between the two deposition films. The two deposition films DF1 and DF2 may have a film structure of the same order. In FIG. 7B, the two deposition films DF1 and DF2 may be disposed such that the reflection layer RL is formed on the base film DF. An adhesive layer AD is formed by pressing the two deposition films DF1 and DF2 and curing the adhesive. Thus, the two deposition films DF1 and DF2 are bonded to each other by the adhesive layer AD to form a laminate CDF.

Referring to FIGS. 7B and 7C, the laminate CDF is cut in a predetermined form. Since light emitted from a display panel must impinge on one end of the base film BF, the cutting of the laminate CDF must be done considering this. In one embodiment, the stacked structure CDF is cut in the form of pentahedron, having a base attached to a top surface of the display panel is quadrangular. In other embodiments, the stacked structure CDF may be cut to have another form or shape.

Cut surfaces of the cut laminate CDF are polished to be planarized. This polishing operation is carried out to prevent light impinging or emitted through the cutting surfaces from being scattered. Thus, an optical member OPM is completed. Formation of the display apparatus may be completed by attaching the optical member OPM to display panels.

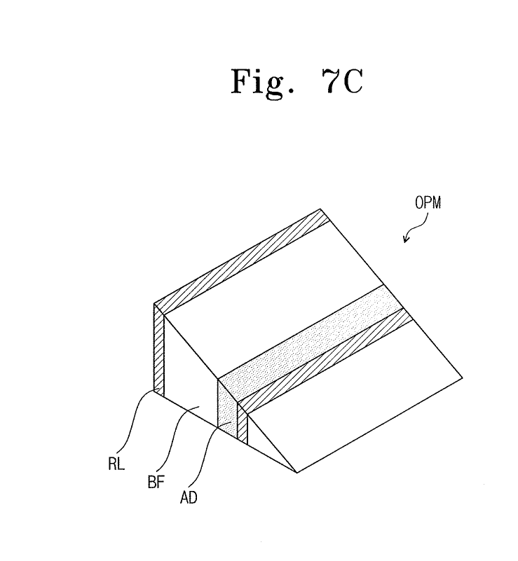

FIG. 8 illustrates two laminated sheets OPK1 and OPK2 of an optical member and an adhesive layer AD therebetween, in a display apparatus according to another embodiment. Referring to FIG. 8, this embodiment may be substantially the same as the embodiment of FIGS. 1 to 5, except for a laminated sheet.

More specifically, stacked sheets OPK1 and OPK2 include a base film BF, an interleaved adhesive layer ADH, and a reflection film RF. The base film BF may be substantially identical to the base film as explained with reference to FIG. 4.

The interleaved adhesive layer ADH is provided at one surface of the base film BF. The interleaved adhesive layer ADH allows the base film BF and the reflection film RF to adhere to each other. The interleaved adhesive layer ADH may be made of a material, for example, having a lower refractive index than a material of the base film BF. The interleaved adhesive layer ADH may be made of the same material as the adhesive layer AD.

In the embodiment of FIG. 5, total reflection is possible when an incident angle of an incident light is greater than a critical angle and the incident angle impinges on the adhesive layer AD. On the other hand, the reflection layer RL allows light to be reflected only at a reflectivity of a metal, but does not allow light to be totally reflected.

In the embodiment of FIG. 8, the adhesive layer AD and the interleaved adhesive layer ADH are formed on respective surfaces of the base film BF. Thus, total reflection may occur at the boundary between the base film BF and the adhesive layer AD, and the boundary between the base film BF and the interleaved adhesive layer ADH, only if an incident angle of incident light is equal to or greater than the critical angle. Thus, in the embodiment of FIG. 8, the interleaved adhesive layer ADH is added to increase the total reflection efficiency. As a result, a ratio of emitted light to incident light may increase.

The reflection film RF is disposed on one surface of the interleaved adhesive layer ADH, and is disposed on the base film BF with the interleaved adhesive layer ADH interposed therebetween and facing the base film BF. The reflection layer RF may an Enhanced Specular Reflector (ESR) film made, for example, of a polymeric material. The ESR film reflects light based on a difference in refractive index between two different polymeric materials.

The reflection film RF serves to reflect light traveling to the boundary with the adhesive layer AD and the boundary with the interleaved adhesive layer ADH. The reflection film RF has several advantages as set forth below, as compared to the reflection layer RL explained with reference to FIGS. 1 to 5.

Because the reflection layer RL is formed by a deposited metal, a contaminant may be introduced during deposition to contaminate the reflection layer RL. However, the reflection film RF does not suffer from contamination because the reflection film RF is not formed by a deposition process. In addition, the reflection layer RL may suffer from chromatic dispersion of reflected light depending on an incident light, while the reflection film RF does not suffer from chromatic dispersion.

Moreover, the reflection film RF may have a higher reflectivity than the reflection layer RL. For example, when the reflection layer RL is made of aluminum, a reflectivity of the aluminum is about 85˜90 percent while a reflectivity of the ESR film is about 98 percent.

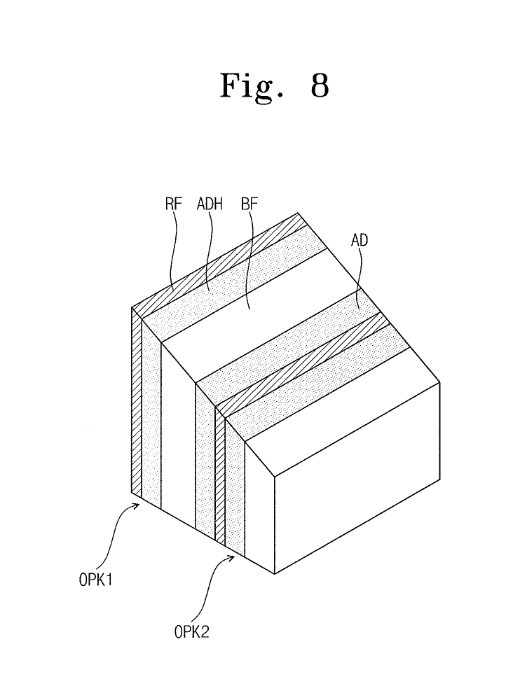

FIG. 9 is a graph illustrating a ratio of reflected light depending on the number of reflections. In FIG. 9, an ESR film used as a material of a reflection film RF and aluminum used as a material of a reflection layer RL are compared with each other. Referring to FIG. 9, it may be seen that the ratio of reflected light rapidly varies as the number of reflections increases. This is because the reflectivity of the ESR film is higher than that of aluminum.

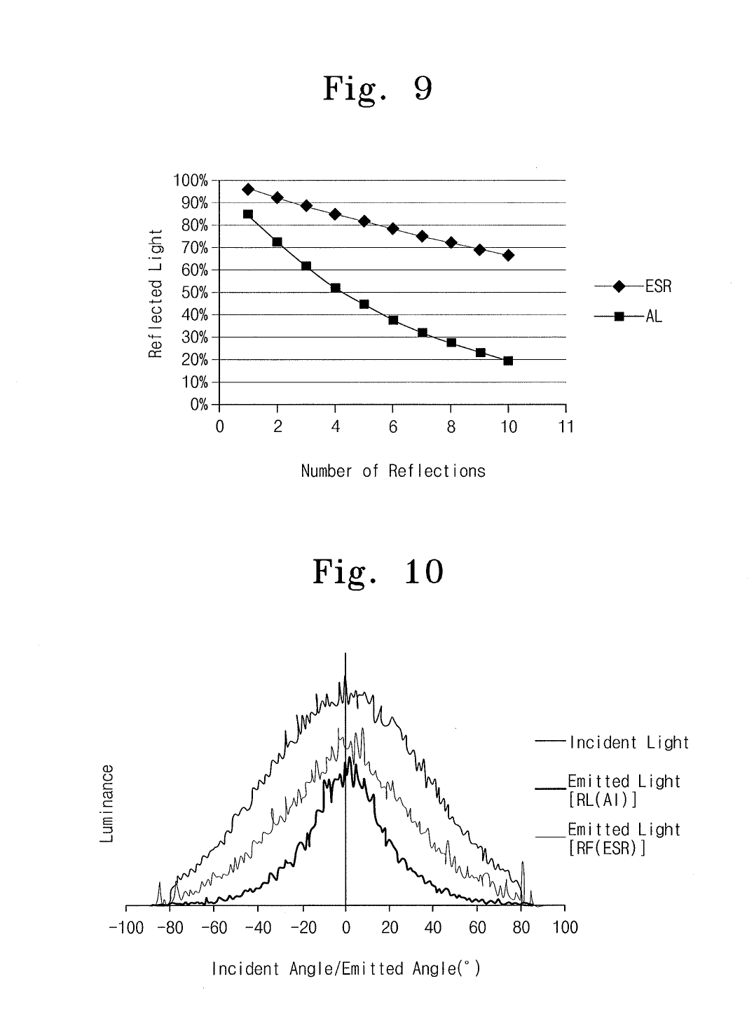

FIG. 10 is a graph illustrating the luminance of incident and emitted light at a plurality of incident/emission angles. In FIG. 10, the reflection film RF made of an ESR film and the reflection layer RL made of aluminum are shown as an example.

Referring to FIG. 10, it may be seen that emitted light of a laminated sheet employing an ESR film according to another embodiment exhibits a higher front emission rate at an angle of zero degrees than emitted light of a laminated sheet employing a reflection layer according to another embodiment. More specifically, a front emission rate is 77 percent in an embodiment employing the ESR film and a front emission is 64 percent in an embodiment employing aluminum, i.e., a difference between the front emission rates is therefore 13 percent.

Moreover, a higher intensity ratio of illumination is exhibited in an embodiment employing an ESR film than an embodiment employing aluminum. In an embodiment employing an ESR film, a value obtained by integrating a waveform of emitted light for total emission angles is 64 percent of a value obtained by integrating a waveform of an incident light for total incident angles.

In an embodiment employing aluminum, a value obtained by integrating a waveform of emitted light for total emission angles is 38 percent of a value obtained by integrating a waveform of an incident light for total incident angles. Thus, an intensity of illumination in the embodiment employing an ESR film is 28 percent higher than that in the embodiment employing aluminum.

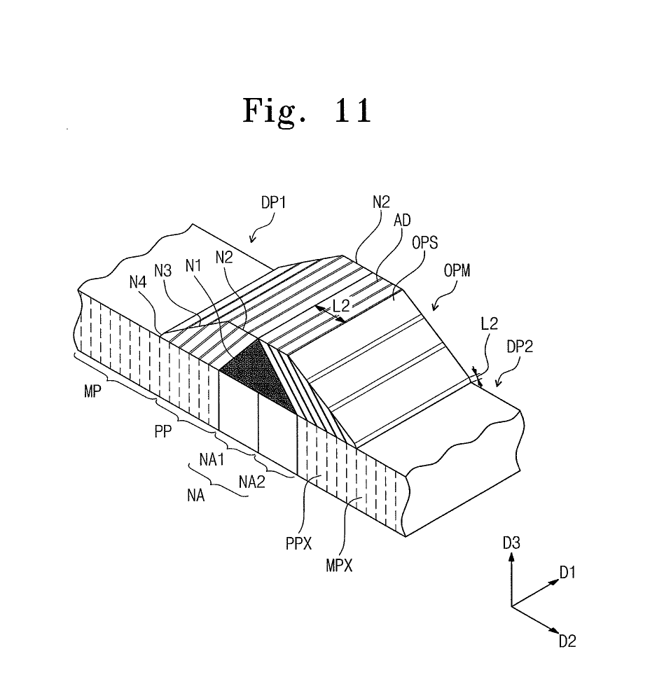

FIGS. 11 to 13 illustrate shapes of optical members OPM according to various embodiments. A shape of the optical member OPM may be formed, for example, by a process of cutting a laminate during fabrication of the optical member OPM.

Referring to FIG. 11, the optical member OPM may be in form of polyhedron having at least six faces. More specifically, in FIG. 11, the optical member OPM having a heptahedral shape is shown as an example. The optical member OPM includes a first side face N1 attached to a supporter SP, a second side face N2 connected to the first side face N1, a third side face N3 connected to the second side face N2, a fourth side face N4 connected to the third side face N3, a base face attached to display panels DP1 and DP2, and top and bottom faces facing each other in a first direction D1.

The second side face N2, the third side face N3, and the fourth side face N4 may have different inclined angles relative to a plane formed by first and second directions D1 and D2. The inclined angles may be greater or smaller in the order of the second side face N2, the third side face N3, and the fourth side face N4.

A shorter-side direction length L1 of the second side face N2 may be equal to or greater than zero, and may be freely adjusted within a range smaller than a length of the base side of the optical member OPM. A shorter-side direction length L2 of the fourth side face N4 is equal to or greater than zero, and may be freely adjusted within a range smaller than a shorter-side direction length of the first side face N1. Both the shorter-side direction length L1 of the second side face N2 and the shorter-side direction length L2 of the fourth side face N4 cannot be zero. This is because if both the lengths L1 and L2 are zero, this embodiment is identical to the embodiment described with reference to FIGS. 1 to 5.

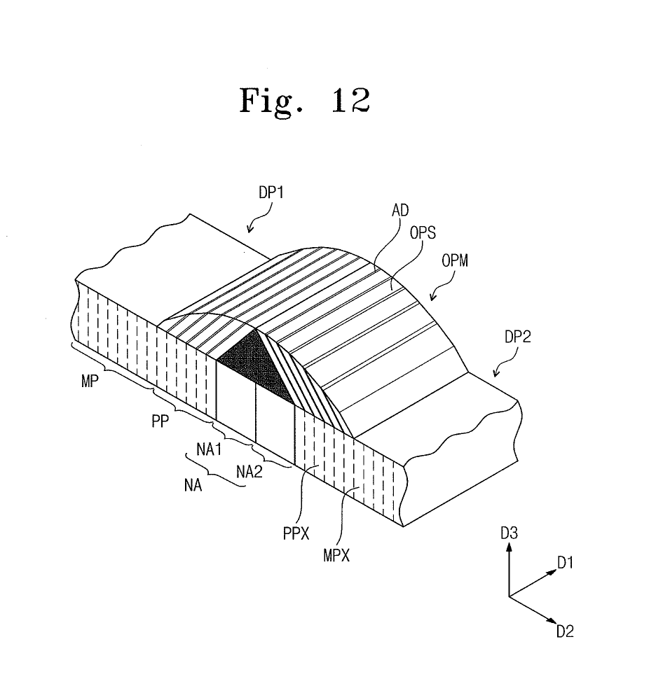

Referring to FIG. 12, inclined angels of the other ends of laminated sheets OPS included in the optical member OPM may be different from each other. Thus, sections of the other ends of the laminated sheets OPS may have different areas. If the number of the laminated sheets OPS is n (n being a positive integer), the optical member OPM may be in the form of polyhedron having n+4 faces. Thus, a viewing angle of an image displayed through the optical member OPM may be improved.

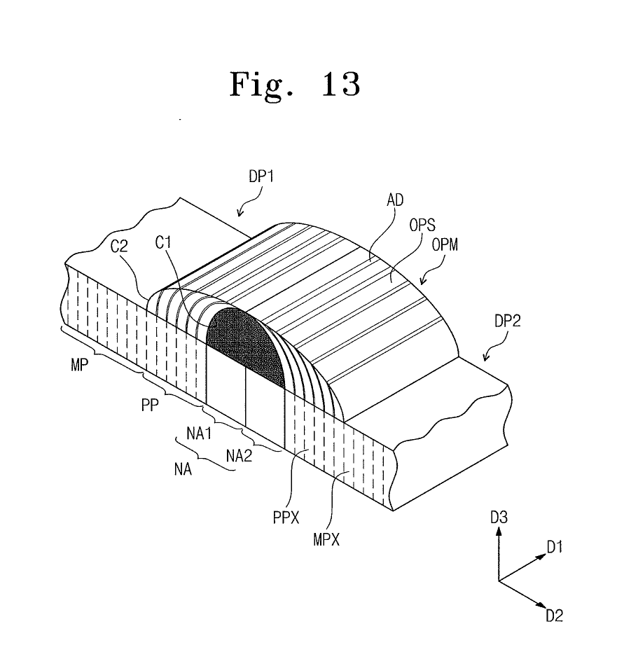

Referring to FIG. 13, a face on which an image of the optical member OPM is displayed may be curved. The optical member OPM may include a first curved face C1 attached to a supporter SP, a second curved face C2 connected to the first curved face C1, a base face attached to display panels DP1 and DP2, and top and bottom faces facing each other in a first direction D1.

The first curved face C1 and the second curved face C2 may have different curvatures. Sections of the other ends of laminated sheets OPS may have different areas according to the curvature of the second curved face C2. Thus, a viewing angle of an image displayed through the optical member OPM may be improved.

The supporter SP may be in the form of half-cylinder. The supporter SP may have the same radius of curvature as the first curved face C1 to support the optical member OPM.

According to one or more of the aforementioned embodiments, an image cut-off problem and an image distortion phenomenon are prevented from occurring at the edge between a plurality of display panels. Thus, a high-quality large screen can be provided.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A multi-panel display apparatus, comprising:
first and second display panels, each display panel including a display area to display an image and a connection non-display area adjacent the display area; and
an optical member having a first side, corresponding to portions of the display areas of the first and second display panels, and a second side, corresponding to the connection non-display areas of the first and second panels, connection non-display areas located between the display areas of the first and second display panels, the optical member to display images from portions of the display areas of the first and second display panels,
wherein the optical member includes an adhesive layer between at least two laminated sheets, each laminated sheet including a base film made of a transparent material having a first refractive index and a reflection layer at a first surface of the base film made of metal, and wherein the adhesive layer is provided at a second surface of the base film and is made of a material having a second refractive index less than the first refractive index.

2. The apparatus as claimed in claim 1, wherein a shape of the optical member is a polyhedron having at least five faces.

3. The apparatus as claimed in claim 1, wherein the optical member includes a curved surface to display the image.

4. The apparatus as claimed in claim 1, wherein the display area of each of the first and second display panels includes:
a main pixel portion; and
a peripheral pixel portion between the main pixel portion and a corresponding connection non-display area, wherein the optical member is disposed on the peripheral pixel portion.

5. The apparatus as claimed in claim 4, wherein:
a first end of each of the laminated sheets corresponds to a single pixel array of the peripheral pixel portion, and
a second end of each of the laminated sheets is included at a different angle from the first end of each of the laminated sheets.

6. The apparatus as claimed in claim 5, wherein sections of the second ends of the laminated sheets have at least two different inclined angles.

7. The apparatus as claimed in claim 1, further comprising:
a supporter on the connection non-display areas of the first and second display panels to support the optical member.

8. The apparatus as claimed in claim 7, wherein the laminated sheets are substantially parallel to a side surface of the supporter.

9. The apparatus as claimed in claim 1, wherein a portion of light impinging on one end of the base film is totally reflected at a boundary between the base film and the adhesive layer.

10. The apparatus as claimed in claim 1, wherein the base film is made of polycarbonate (PC), polyethylene terephthalate (PET), polyurethane (PU), or polymethylmethacrylate (PMMA).

11. The apparatus as claimed in claim 1, wherein the reflection layer is made of aluminum, silver, nickel, or a combination thereof.

12. A multi-panel display apparatus, comprising:
first and second display panels, each including a display area to display an image and a connection non-display area adjacent to the display area; and
an optical member having a first side corresponding to portions of the display areas of the first and second display panels and a second side on the connection non-display areas of the first and second display panels, the connection non-display areas located between the display areas of the first and second display panels, the optical member to display images from portions of the display areas of the first and second display panels,
wherein the optical member includes an adhesive layer between at least two laminated sheets, each of the laminated sheets including:
a base film made of a transparent material having a first refractive index,
an interleaved adhesive layer at a first surface of the base film made of a material having a second refractive index less than the first refractive index, and
a reflection film on the base film and the interleaved adhesive layer disposed therebetween to face the base film, and wherein the adhesive layer is provided at a second surface of the base film and is made of a material having a third refractive index less than the first refractive index.

13. The apparatus as claimed in claim 12, wherein the reflection film is an Enhanced Specular Reflector (ESR) film.

14. The apparatus as claimed in claim 12, wherein the second refractive index and the third refractive index are substantially equal to each other.

15. The apparatus as claimed in claim 12, wherein some light impinging on one end of the base film is totally reflected at a boundary between the base film and the adhesive layer.

16. A method of making a multi-panel display apparatus, the method comprising:
forming at least two laminated sheets;
forming a laminate in which an adhesive layer is disposed between the laminated sheets;
cutting the laminate in a predetermined shape; and
attaching the cut laminate to a plurality of display panels.

17. The method as claimed in claim 16, wherein forming the laminated sheets includes:
preparing a base film; and
depositing a metal on the base film to form a reflection layer.

18. The method as claimed in claim 16, wherein forming the laminate includes:
coating an adhesive between the laminated sheets;
pressing the laminated sheets coated with the adhesive; and
curing the adhesive to form the adhesive layer.

19. A multi-panel display apparatus, comprising:
a first display panel;
a second display panel; and
an optical waveguide over display areas of the first and second display panels, wherein the optical waveguide passes light from the display areas to inclined surfaces overlapping a region between the display areas of the first and second display panels, and wherein the light emitted from each display area corresponds to a different image.

20. The apparatus as claimed in claim 19, wherein:
a first inclined surface of the optical waveguide overlaps a peripheral portion of the display area of the first display panel, and
a second inclined surface of the optical waveguide overlaps a peripheral portion of the display area of the second display panel, the first inclined surface connected to the second inclined surface at a location which corresponds to a boundary between non-display areas of the first and second display panels.
